(19) United States
(12) Patent Application Publication
(10) Pub. No.: US 2009/0256348 A1
(43) Pub. Date: Oct. 15, 2009

(54) MULTI-ATTACHMENT FITTING

(76) Inventors: Mark S. Bors, Grafton, OH (US); Michael L. Malck, North Olmsted, OH (US); William E. Patton, Columbia Station, OH (US)

Correspondence Address: CALFEE HALTER & GRISWOLD, LLP, 800 SUPERIOR AVENUE, SUITE 1400, CLEVELAND, OH, 44114, US

(21) Appl. No.: 12/100,509

(22) Filed: Apr. 10, 2008

(51) Int. Cl. F16L 47/00; E03C 1/04

(52) U.S. Cl. 285/12; 285/334.1; 285/242; 285/33; 137/603

(57) ABSTRACT

A water delivery component includes a fitting that can accommodate different types of connections. For example, a spout shank assembly or a valve assembly includes a fitting that can interface with hosing, piping or other conduit using a quick-connect method or a PEX connect method.

### FIELD

The invention relates generally to the field of plumbing fixtures and, more particularly, to a plumbing fixture having a single fitting capable of supporting different types of connections.

### BACKGROUND

Many plumbing fixtures include a spout that is mounted on a deck or wall, wherein the spout interfaces with a tube or shank extending through the deck or wall for connection to water supply pipes on the other side of the deck or the wall. The spout is connected to the water supply pipes through valve assemblies that allow a user to control the flow rate and the temperature of the water delivered through the tube and out the spout. Hoses are used to connect the tube (and, thus, the spout) to the valve assemblies and the valve assemblies to the water supply pipes. The tube has a fitting for interfacing with a hose extending between the tube and the valve assemblies. Similarly, each valve assembly has a pair of fittings for interfacing with the hose extending between the tube and the valve assembly and a hose extending between the valve assembly and a corresponding one of the water supply pipes.

Conventionally, the fitting on the tube and the fittings on the valve assemblies accommodate only one type of connection. For example, a fitting might only accommodate connection to a quick-connect hose. In this case, the quick-connect hose is generally connected to the fitting by interfacing a quick-connect connector on an end of the quick-connect hose with the fitting. Since the quick-connect connector is designed to slide over and lock onto the fitting, no tools are needed for the quick-connect connector to interface with the fitting. The quick-connect connector interfaces with the fitting to form a water-tight connection between the quick-connect hose and the fitting. As another example, a fitting might only accommodate connection to a PEX (i.e., crosslinked polyethylene) hose. In this case, the PEX hose is generally connected to the fitting by sliding the PEX hose over the fitting and then using a tool to crimp a metal ring around a portion of the PEX hose surrounding the fitting, thereby forming a water-tight connection between the PEX hose and the fitting.

A fitting designed to interface with a quick-connect hose will generally not work with a PEX hose, just as a fitting designed to interface with a PEX hose will generally not work with a hose having quick-connect connectors on its ends. Consequently, there is a need in the art for a water delivery component (e.g., a spout tube, a valve assembly) having a fitting that can accommodate different types of connections.

### SUMMARY

In view of the above, it is an exemplary aspect to provide a water delivery component (e.g., a spout tube, a valve assembly) having a fitting that can accommodate different types of connections.

It is another exemplary aspect to provide a spout shank assembly having a single fitting that can interface with either of a quick-connect hose or a PEX hose.

It is yet another exemplary aspect to provide a valve assembly having a single fitting that can interface with either of a quick-connect hose or a PEX hose.

It is still another exemplary aspect to provide a valve assembly having a first fitting that can interface with either of a quick-connect hose or a PEX hose and a second fitting that can interface with either of a quick-connect hose or a PEX hose.

It is still another exemplary aspect to provide a first water delivery component (e.g., a spout tube, a valve assembly) having a first fitting that can accommodate different types of connections and a second water delivery component (e.g., a spout tube, a valve assembly) having a second fitting that can accommodate different types of connections, wherein the first water delivery component and the second water delivery component can be connected by a hose with the hose being connected to the first fitting with a first type of connection and connected to the second fitting with a second type of connection.

Numerous other advantages and features will become readily apparent from the following detailed description of exemplary embodiments, from the claims and from the accompanying drawings.

### BRIEF DESCRIPTION OF THE DRAWINGS

The above aspects and additional aspects, features and advantages will become readily apparent by describing in detail exemplary embodiments thereof with reference to the attached drawings, wherein like reference numerals denote like elements, and:

FIGS. 1A-1J show a water delivery system, according to an exemplary embodiment. FIG. 1A is an assembled perspective view of the water delivery system interfaced with a quick-connect hose assembly. FIG. 1B is a cross-sectional view of the water delivery system of FIG. 1A, along line A-A. FIG. 1C is an exploded perspective view of the water delivery system of FIG. 1A. FIG. 1D is a detailed view of the region circled in FIG. 1A. FIG. 1E is a cross-sectional view of the detailed view of FIG. 1D, along line B-B. FIG. 1F is an assembled perspective view of the water delivery system interfaced with a PEX hose assembly. FIG. 1G is a cross-sectional view of the water delivery system of FIG. 1F, along line A-A. FIG. 1H is an exploded perspective view of the water delivery system of FIG. 1F. FIG. 1I is a detailed view of the region circled in FIG. 1F. FIG. 1J is a cross-sectional view of the detailed view of FIG. 1I, along line B-B.

FIGS. 2A-2B show a nipple body of a spout shank assembly, according to an exemplary embodiment, for use in the water delivery system of FIGS. 1A-1J. FIG. 2A is a perspective view of the nipple body. FIG. 2B is a cross-sectional view of the nipple body shown in FIG. 2A, along line A-A.

FIGS. 3A-3B show a valve body of a valve assembly, according to an exemplary embodiment, for use in the water delivery system of FIGS. 1A-1J. FIG. 3A is an assembled perspective view of the valve body. FIG. 3B is a cross-sectional view of the valve body of FIG. 3A, along line A-A.

FIGS. 4A-4C show a quick-connect connector, according to an exemplary embodiment. FIG. 4A is a perspective view of the quick-connect connector. FIG. 4B is a side elevational view of the quick-connect connector. FIG. 4C is a cross-sectional view of the quick-connect connector of FIG. 4A, along line A-A.

### DETAILED DESCRIPTION

While the general inventive concept is susceptible of embodiment in many different forms, there are shown in the drawings and will be described herein in detail specific embodiments thereof with the understanding that the present disclosure is to be considered as an exemplification of the principles of the general inventive concept. Accordingly, the general inventive concept is not intended to be limited to the specific embodiments illustrated herein.

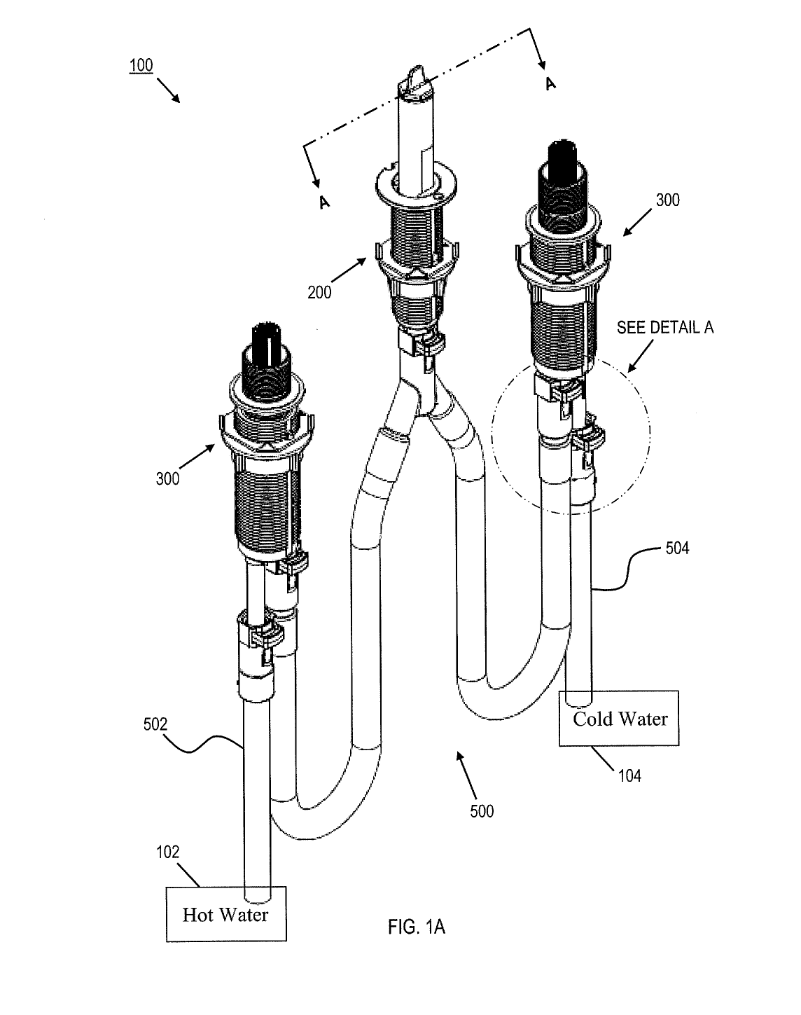

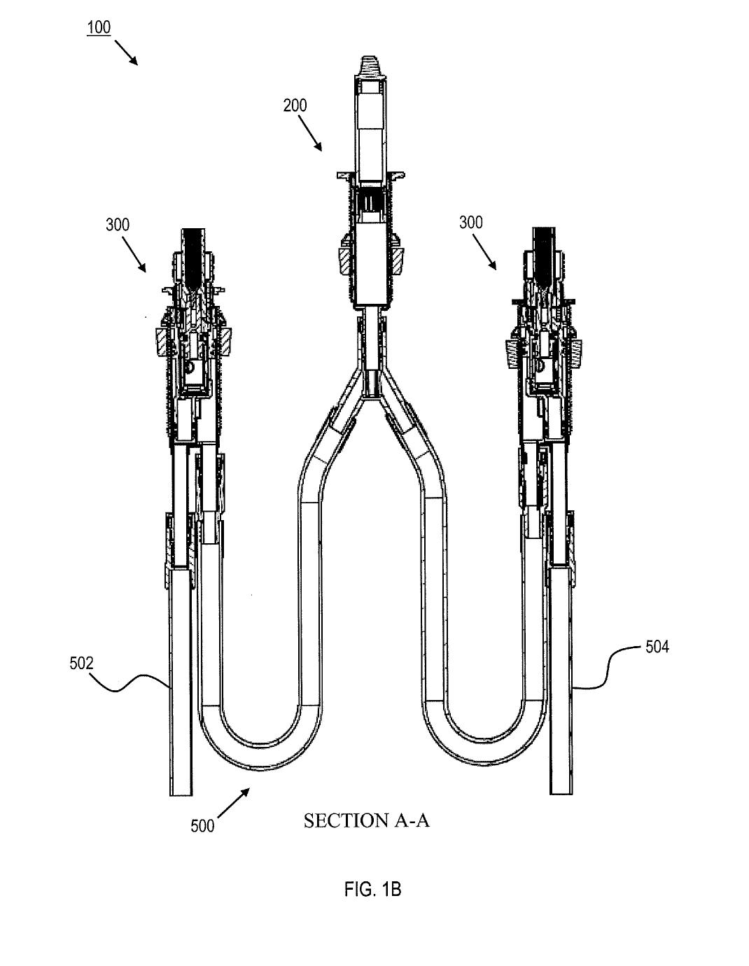

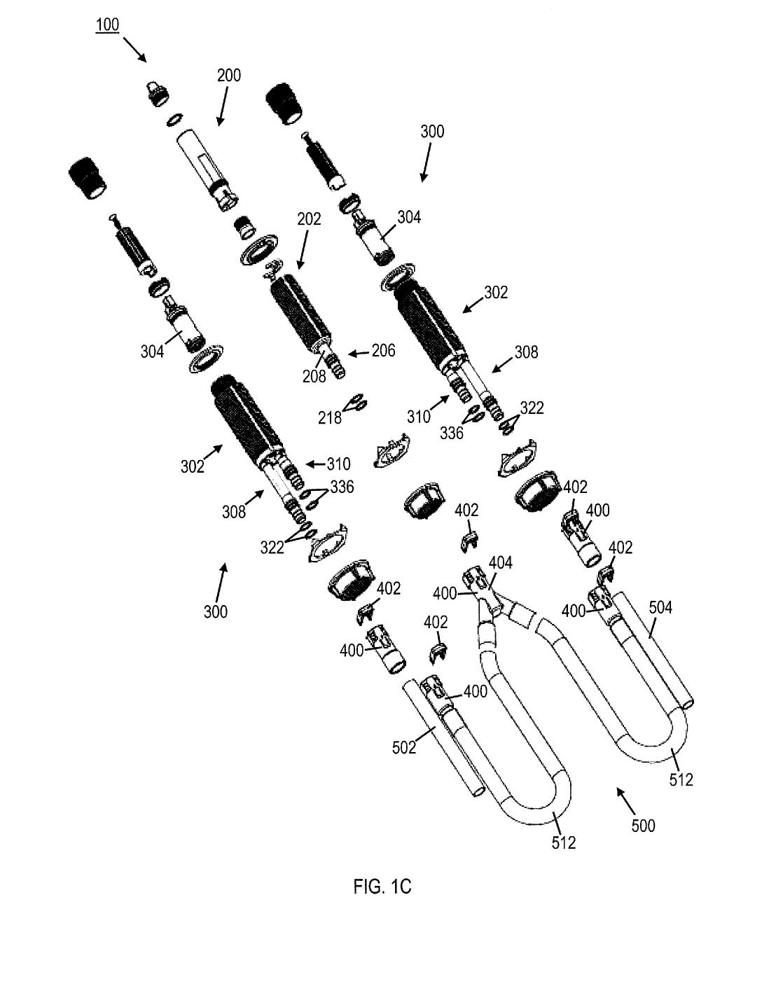

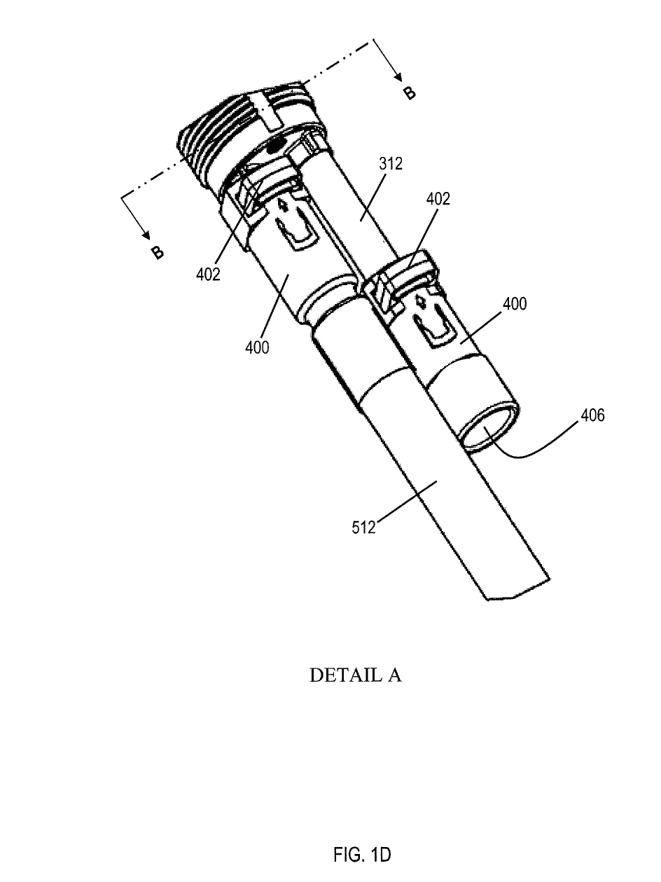

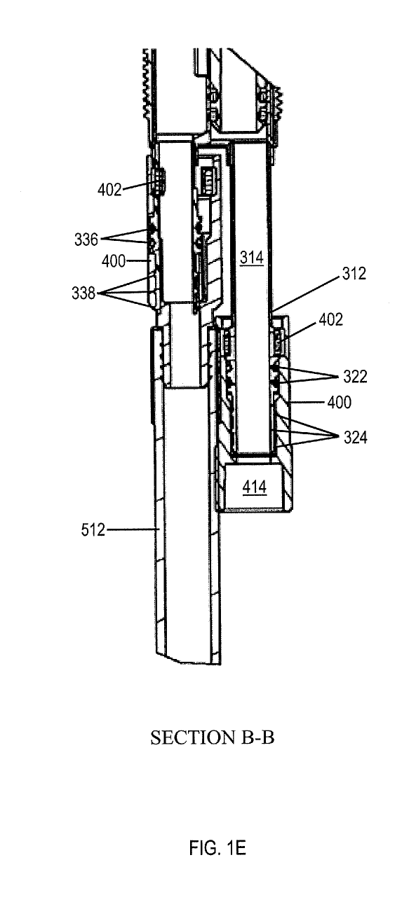

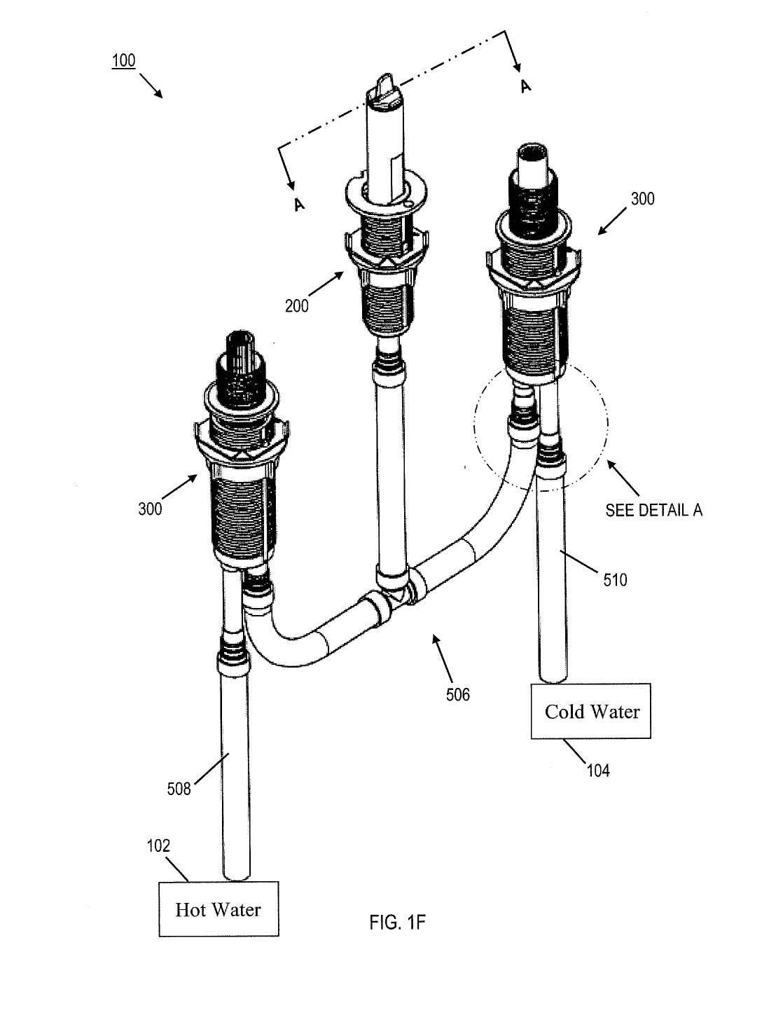

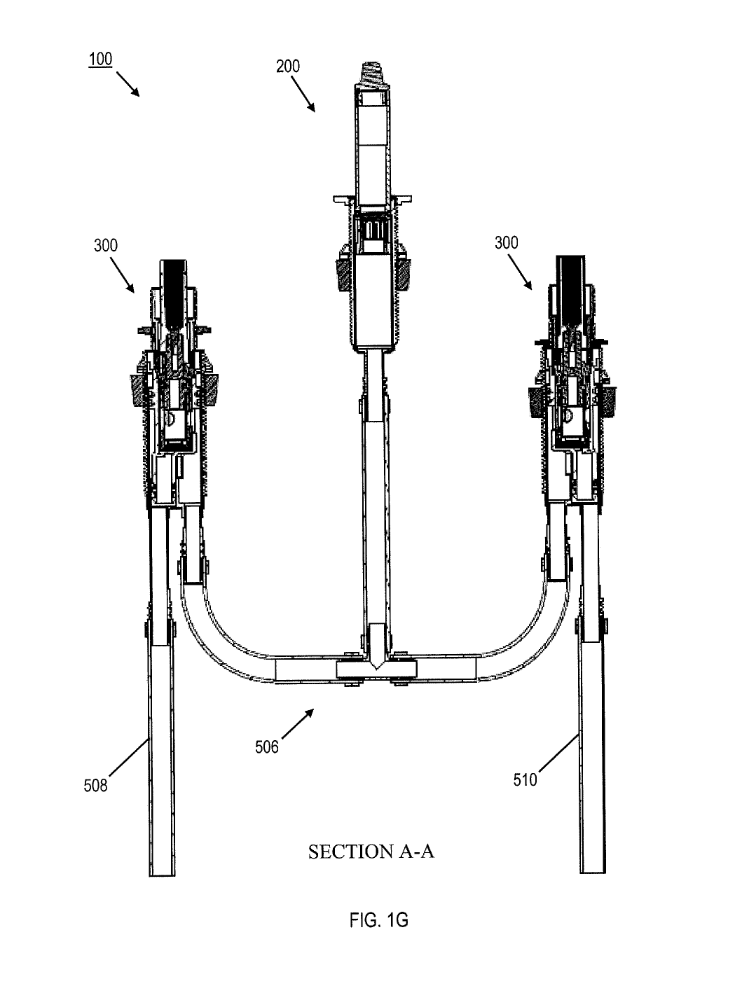

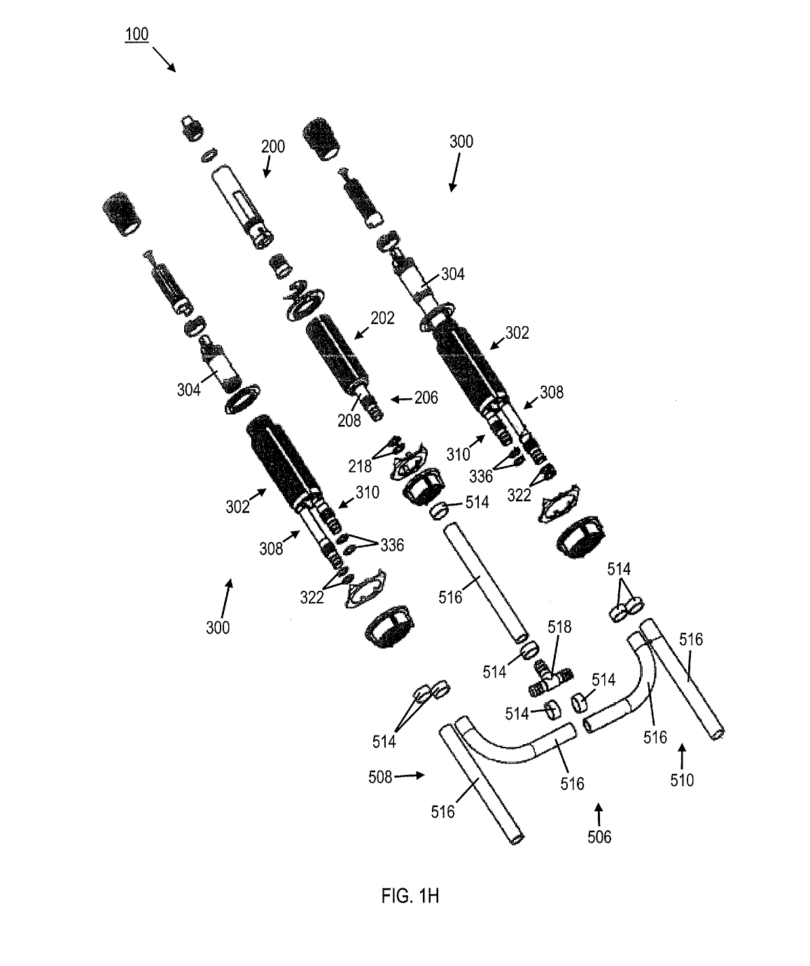

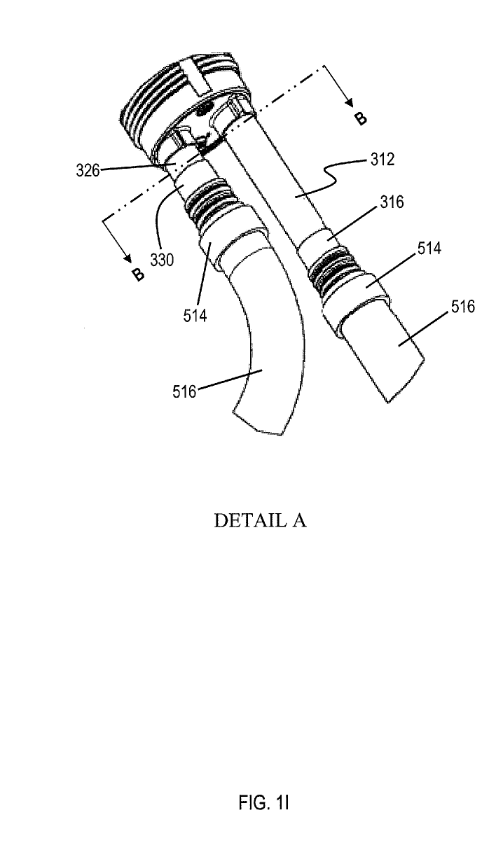

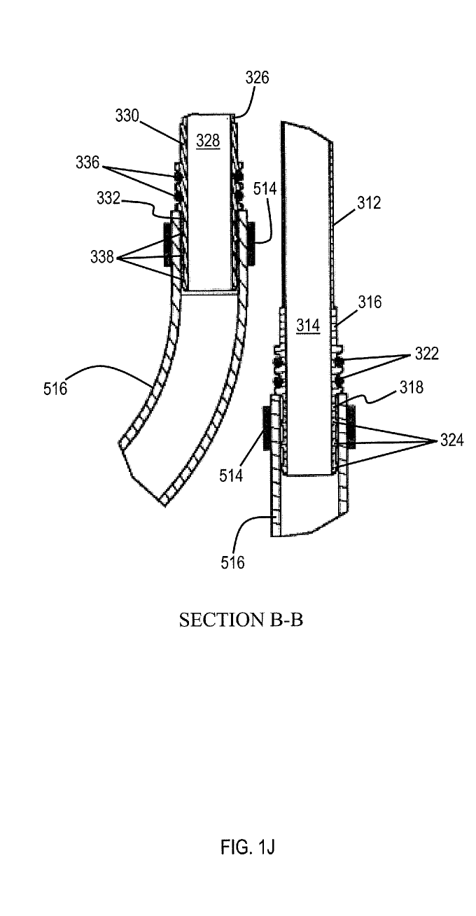

A water delivery system 100 (see FIGS. 1A-1J), according to an exemplary embodiment, will now be described. The water delivery system 100 includes a spout shank assembly 200, two valve assemblies 300 and a hose assembly 500 (see FIGS. 1A-1E) or a hose assembly 506 (see FIGS. 1F-1J). The spout shank assembly 200 and the valve assemblies 300 are operable to be installed so as to extend through a mounting surface (not shown). A hot water source 102 and a cold water source 104 are located on one side of the mounting surface.

The hose assembly 500 or 506 forms a conduit that connects the valve assemblies 300 to the spout shank assembly 200 (see FIGS. 1A-1J). Other hose assemblies, such as hose assembly 502 or 508 and hose assembly 504 or 510, can connect the valve assemblies 300 to the hot water source 102 and the cold water source 104, respectively. The water delivery system 100 is operable to deliver water from the hot water source 102 and/or the cold water source 104 through the spout shank assembly 200 and out a spout (not shown) mounted thereon. The valve assemblies 300 control the flow rate and the temperature of the water delivered through the spout shank assembly 200 and out the spout.

In one exemplary embodiment, the hose assemblies 500, 502 and 504 are quick-connect hoses (see FIGS. 1A-1E) for interfacing with the spout shank assembly 200 and the valve assemblies 300 using a quick-connect method, as described below. In one exemplary embodiment, the hose assemblies 506, 508 and 510 are PEX hoses (see FIGS. 1F-1J) for interfacing with the spout shank assembly 200 and the valve assemblies 300 using a PEX-connect method, as described below.

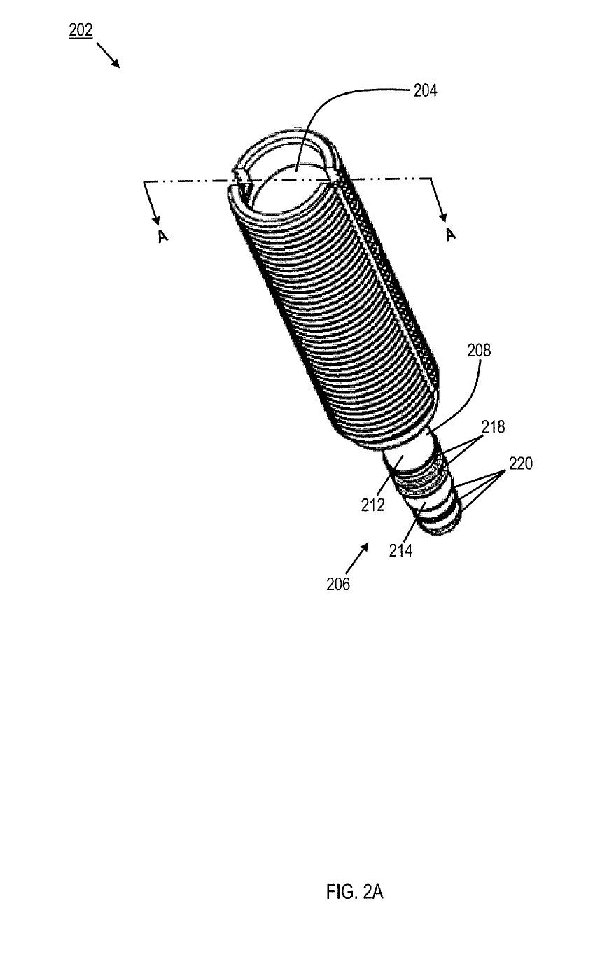

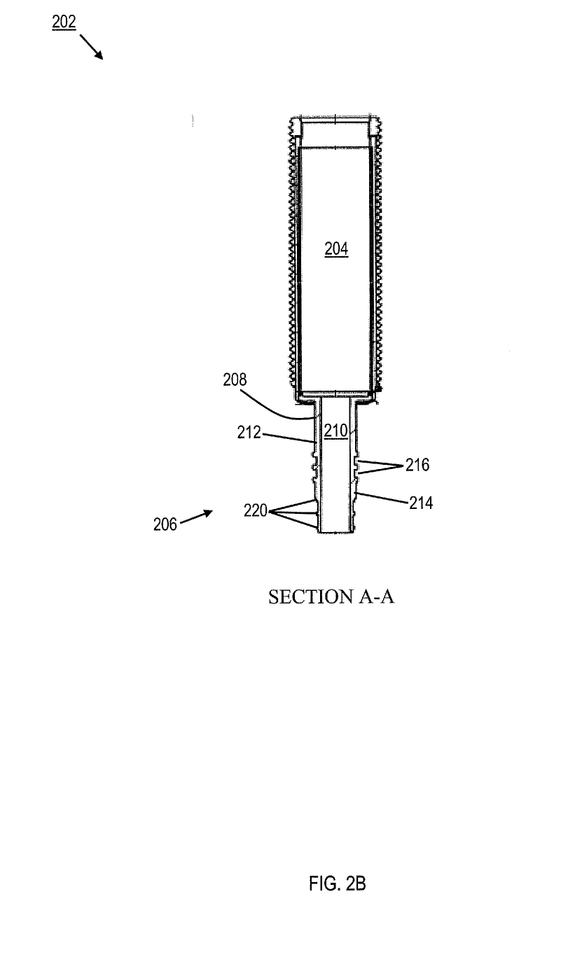

The spout shank assembly 200 includes, among other components, a nipple body 202 that is a generally tubular body having an inner cavity 204 through which a fluid (e.g., water) can flow (see FIGS. 2A-2B). The nipple body 202 includes a connector 206. The connector 206 is a generally tubular nipple 208 having an inner cavity 210 through which a fluid (e.g., water) can flow. The tubular nipple 208 includes an upper portion 212 and a lower portion 214. In one exemplary embodiment, a diameter of the upper portion 212 of the tubular nipple 208 is larger than a diameter of the lower portion 214 of the tubular nipple 208. The upper portion 212 of the tubular nipple 208 includes at least one circumferential groove 216. In one exemplary embodiment, a pair of circumferential grooves 216 is located adjacent to one another on the tubular nipple 208 (see FIG. 2B). The circumferential grooves 216 are operable to receive O-rings 218. The lower portion 214 of the tubular nipple 208 includes at least one circumferential ridge 220. In one exemplary embodiment, three circumferential ridges 220 are located on the tubular nipple 208 (see FIG. 2B). In one exemplary embodiment, the circumferential ridges 220 have the same dimensions. In one exemplary embodiment, the circumferential ridges 220 are evenly spaced. The connector 206 forms a multi-attachment fitting operable to interface with hosing, piping or other conduit using at least two different connection methods, as described below.

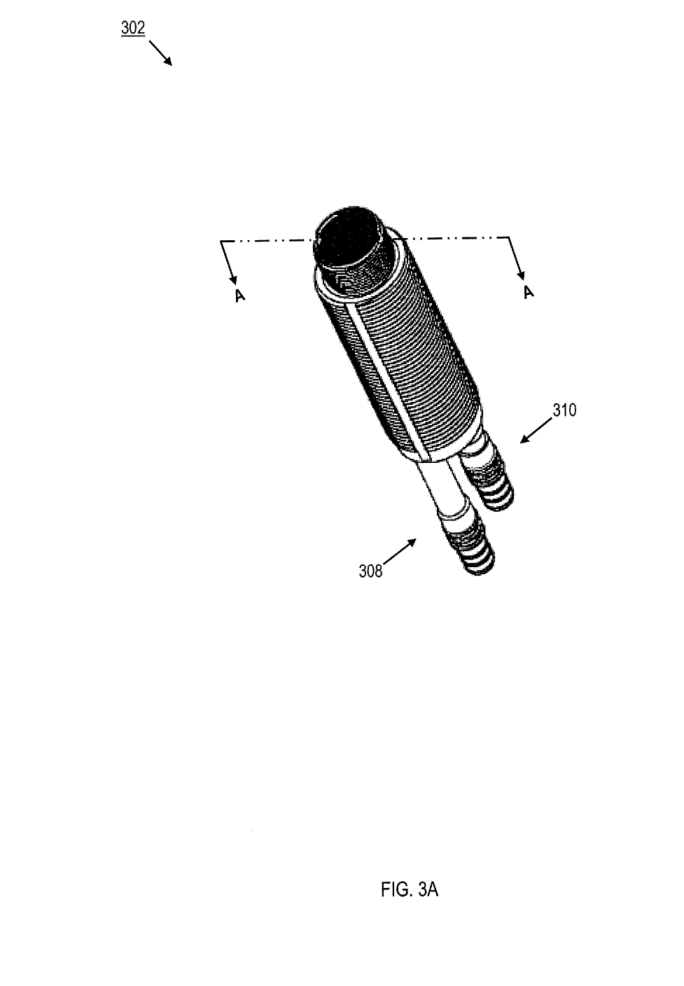

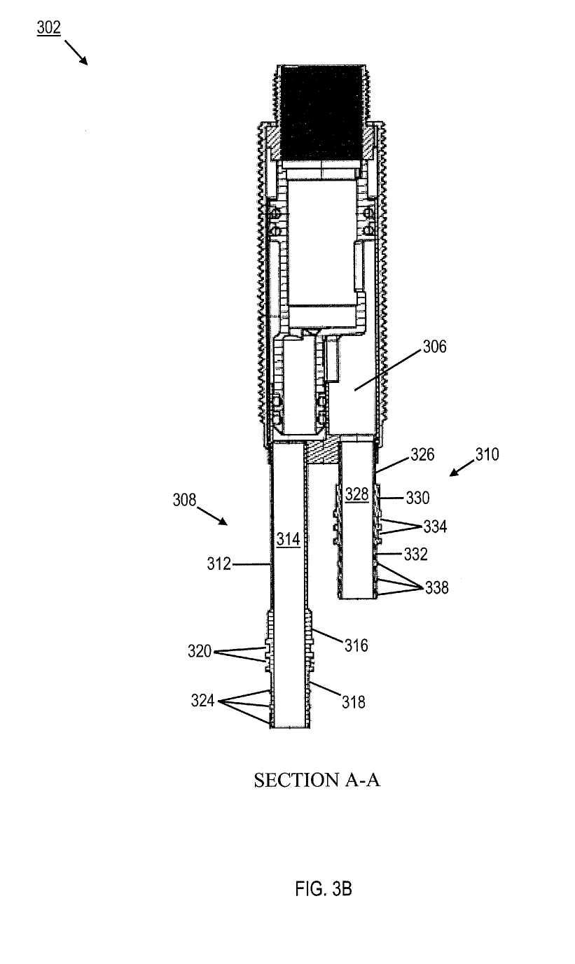

The valve assembly 300 includes, among other components, a valve body 302 for housing a valve cartridge 304. As shown in FIGS. 3A-3B, the valve body 302 is a generally tubular body having an inner cavity 306 through which a fluid (e.g., water) can flow (see FIG. 3B). The valve body 302 includes an input connector 308 and an output connector 310 extending from an end of the valve body 302. A fluid flow path is defined between the input connector 308 and the output connector 310 (see FIG. 3B). In one exemplary embodiment, the input connector 308 has a length that differs from a length of the output connector 310. In one exemplary embodiment, the input connector 308 and the output connector 310 are parallel to one another.

The input connector 308 is a generally tubular nipple 312 having an inner cavity 314 through which a fluid (e.g., water) can flow. At least a portion of the tubular nipple 312 defines an upper portion 316 and a lower portion 318.

In one exemplary embodiment, a circumference of an outer surface of the upper portion 316 of the tubular nipple 312 is larger than a circumference of an outer surface of the lower portion 318 of the tubular nipple 312. The upper portion 316 of the tubular nipple 312 includes at least one circumferential groove 320. In one exemplary embodiment, a pair of circumferential grooves 320 is located adjacent to one another on the tubular nipple 312 (see FIG. 3B). The circumferential grooves 320 are operable to receive O-rings 322. The lower portion 318 of the tubular nipple 312 includes at least one circumferential ridge 324. In one exemplary embodiment, three circumferential ridges 324 are located on the tubular nipple 312 (see FIG. 3B). In one exemplary embodiment, the circumferential ridges 324 have the same dimensions. In one exemplary embodiment, the circumferential ridges 324 are evenly spaced. The input connector 308 forms a multi-attachment fitting operable to interface with hosing, piping or other conduit using at least two different connection methods, as described below.

The output connector 310 is a generally tubular nipple 326 having an inner cavity 328 through which a fluid (e.g., water) can flow. At least a portion of the tubular nipple 326 defines an upper portion 330 and a lower portion 332.

In one exemplary embodiment, a circumference of an outer surface of the upper portion 330 of the tubular nipple 326 is larger than a circumference of an outer surface of the lower portion 332 of the tubular nipple 326. The upper portion 330 of the tubular nipple 326 includes at least one circumferential groove 334. In one exemplary embodiment, a pair of circumferential grooves 334 is located adjacent to one another on the tubular nipple 326 (see FIG. 3B). The circumferential grooves 334 are operable to receive O-rings 336. The lower portion 332 of the tubular nipple 326 includes at least one circumferential ridge 338. In one exemplary embodiment, three circumferential ridges 338 are located on the tubular nipple 326 (see FIG. 3B). In one exemplary embodiment, the circumferential ridges 338 have the same dimensions. In one exemplary embodiment, the circumferential ridges 338 are evenly spaced. The output connector 310 forms a multi-attachment fitting operable to interface with hosing, piping or other conduit using at least two different connection methods, as described below.

After the spout shank assembly 200 is installed in the mounting surface, the spout shank assembly 200 can be connected to a water supply source (e.g. the hot water source 102 and/or the cold water source 104). To connect the spout shank assembly 200 and the water supply source, hosing, piping or other conduit (e.g., the hose assembly 500, 502, 504, 506, 508, 510) extending directly or indirectly from the water supply source is connected to the tubular nipple 208 of the connector 206.

In one exemplary embodiment, at least one valve assembly 300 is installed in the mounting surface so as to be disposed between the water supply source (e.g., the hot water source 102 and/or the cold water source 104) and the spout shank assembly 200 to control delivery (e.g., flow and/or temperature) of the water through the spout shank assembly 200 and out the spout. In one exemplary embodiment, two valve assemblies 300 extend through the mounting surface to allow a user to separately control the flow rate of hot water from the hot water source 102 and cold water from the cold water source 104 through the spout shank assembly 200 and out the spout (see FIGS. 1A-1J).

Once the valve assembly 300 is installed in the mounting surface, the valve body 302 can be connected into the water delivery system 100. In particular, the input connector 308 can be connected to a water supply source (e.g., the hot water source 102 or the cold water source 140) via hosing, piping or other conduit (e.g., hose assembly 502, 504, 508, 510). The output connector 310 can be connected to the spout shank assembly 200 via hosing, piping or other conduit (e.g., hose assembly 500, 506). As noted above, the connector 206 of the spout shank assembly 200 and the input and output connectors 308, 310 of the valve assemblies 300 are multi-attachment fittings operable to interface with hosing, piping or other conduit using at least two different connection methods. For purposes of brevity, only the connector 206 will be described hereafter, as the input and output connectors 308, 310 have similar structure.

In one exemplary embodiment, the connector 206 can interface with hosing, piping or other conduit using a quick-connect method (see FIGS. 1A-1E). The quick-connect method includes using a quick-connect hose assembly, such as hose assembly 500. The quick-connect hose assembly 500 has a quick-connect connector 400 for interfacing with the connector 206 without using any tools. For example, the quick-connect connector 400 can slide onto the connector 206 and then be secured thereto using a quick-connect clip 402 (see FIGS. 1A-1E). In one exemplary embodiment, the quick-connect connector 400 and the quick-connect clip 402 are made from plastic.

In one exemplary embodiment, the quick-connect hose assembly 500 includes a pair of hose segments 512 for extending between the spout shank assembly 200 and the pair of valve assemblies 300 (see FIG. 1C). The hose segments 512 are joined (e.g., at a Y-joint 404), such that water from the hot water source 102 and water from the cold water source 104 can be mixed prior to delivery through the spout. The quick-connect hose assembly 500 includes three quick-connect connectors 400 for connection to the connector 206 of the spout shank assembly 200 and the output connector 310 of each valve assembly 300.

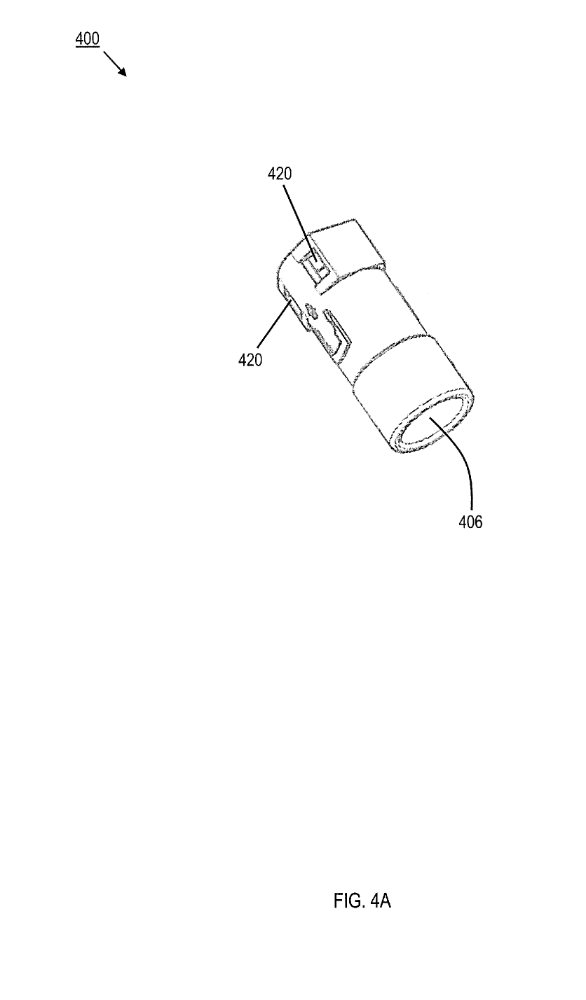

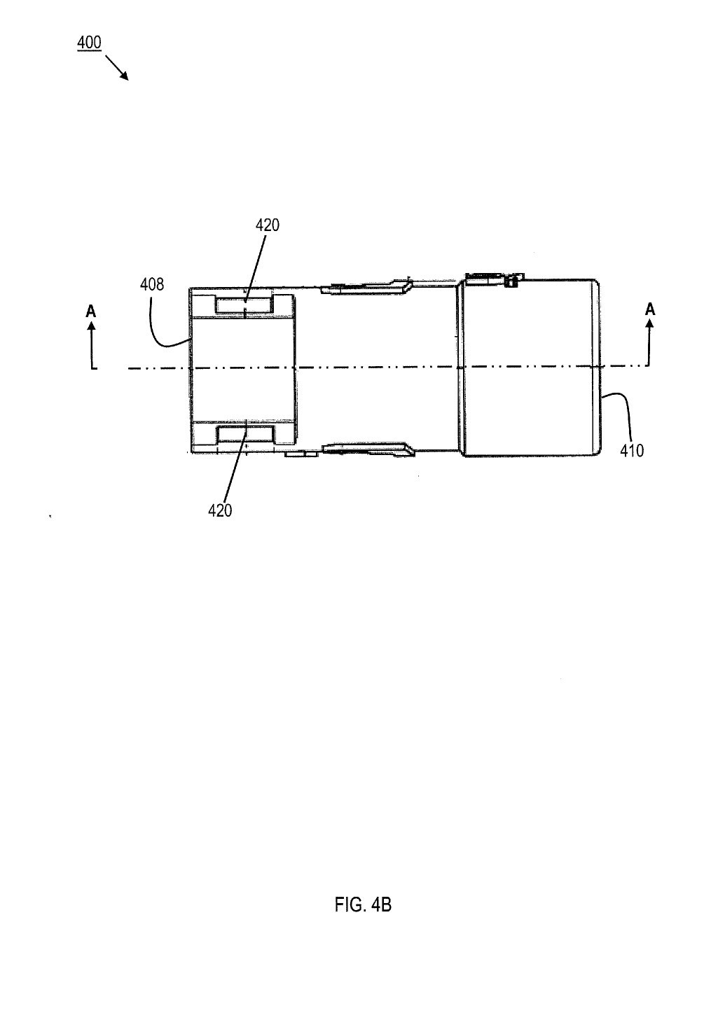

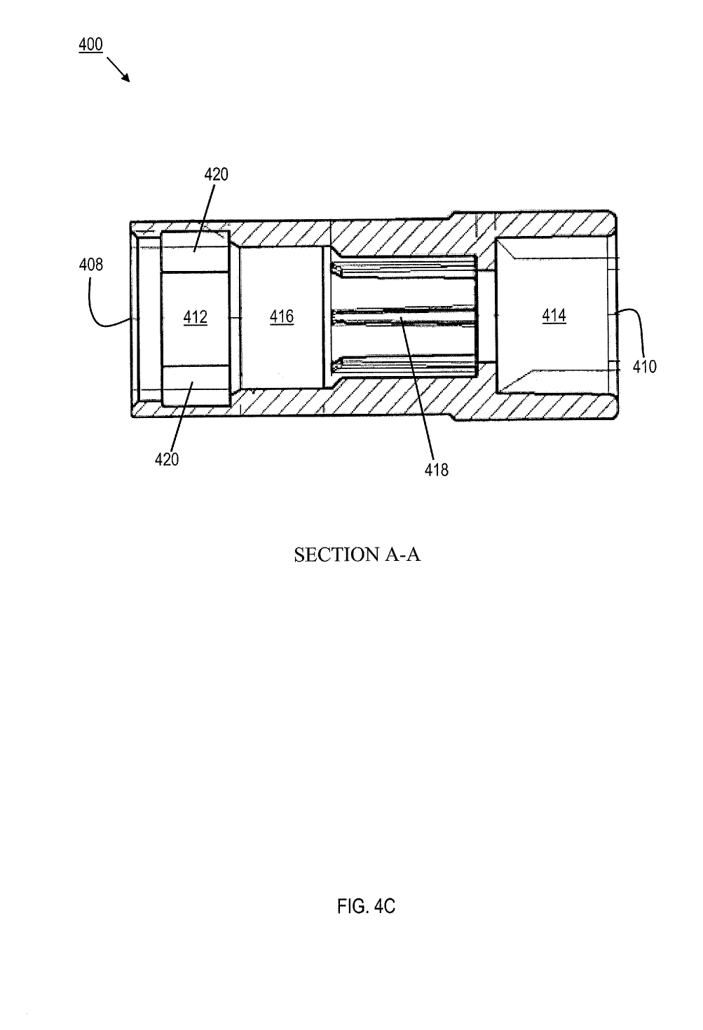

As shown in FIGS. 4A-4C, the quick-connect connector 400 is a generally tubular body having an inner cavity 406 through which a fluid (e.g., water) can flow. The inner cavity 406 extends between a first opening 408 at one end of the tubular body and a second opening 410 at an opposite end of the tubular body. The inner cavity 406 includes a first area 412 adjacent to the first opening 408 and a second area 414 adjacent to the second opening 410. The inner cavity 406 also includes a third area 416 adjacent to the first area 412 and a fourth area 418 adjacent to the second area 414.

The first area 412 is sized to accommodate a tubular nipple (e.g., the tubular nipple 208, 312, 326) of a multi-attachment fitting (e.g., the connector 206, the input connector 308, the output connector 310). Furthermore, the first area 412 includes a pair of openings 420 for receiving the quick-connect clip 402. The third area 416 is sized to accommodate an upper portion (e.g., the upper portion 212, 316, 330) of a multi-attachment fitting (e.g., the connector 206, the input connector 308, the output connector 310). The fourth area 418 is sized to accommodate a lower portion (e.g., the lower portion 214, 318, 332) of a multi-attachment fitting (e.g., the connector 206, the input connector 308, the output connector 310). The second area 414 is sized to accommodate the hose segment 512 interfacing with the quick-connect connector 400 at the second opening 410 of the tubular body.

The quick-connect connector 400 can be connected to a multi-attachment fitting, such as the connector 206, by sliding the quick-connect connector 400 onto the connector 206. In this manner, the O-rings 218 disposed in the grooves 216 of the connector 206 are received in the third area 416 of the quick-connect connector 400 to form a water tight seal between the connector 206 and the quick-connect connector 400. Insertion of the quick-connect clip 402 into the openings 420 in the quick-connect connector 400 prevents the quick-connect connector 400 from becoming dislodged from the connector 206. Thereafter, the quick-connect hose assembly 500 can be removed from the connector 206 by removing the quick-connect clip 402 and sliding the quick-connect connector 400 off of the connector 206. As noted above, the quick-connect hose assembly 500 could also be connected to and removed from the input connector 308 or the output connector 310 of the valve assembly 300 using similar techniques. Accordingly, no tools are needed to install and uninstall the quick-connect hose assemblies (e.g., the hose assemblies 500, 502, 504) with respect to corresponding multi-attachment fittings.

In one exemplary embodiment, the connector 206 can also interface with hosing, piping or other conduit using a PEX-connect method (see FIGS. 1F-1J). The PEX-connect method includes using a PEX hose assembly, such as hose assembly 506. The PEX hose assembly 506 has a hose segment with an inner diameter that fits over the lower portion 214 of the connector 206 but not the upper portion 212 of the connector 206 (see FIGS. 1G and 1J). In this manner, the PEX hose assembly 506 can slide onto the lower portion 214 of the connector 206 and be secured thereto using a crimp ring 514.

In one exemplary embodiment, the PEX hose assembly 506 includes three hose segments 516 for extending between the spout shank assembly 200 and the pair of valve assemblies 300 (see FIG. 1H). The hose segments 516 are joined (e.g., at a T-joint 518) using crimp rings 514, such that water from the hot water source 102 and water from the cold water source 104 can be mixed prior to delivery through the spout. The three hose segments 516 of the PEX hose assembly 506 can be connected to the connector 206 of the spout shank assembly 200 and the output connector 310 of each valve assembly 300 using crimp rings 514.

The hose segment 516 of the PEX hose assembly 506 can be connected to the connector 206 by sliding a portion of the hose segment 516 over the lower portion 214 of the connector 206. Once the lower portion 214 of the connector 206 is surrounded by the portion of the hose segment 516, the crimp ring 514 is positioned around the portion of the hose segment 516 surrounding the lower portion 214 of the connector 206. Thereafter, a tool is used to deform (i.e., crimp) the crimp ring 514 to deform the portion of the hose segment 516 surrounding the lower portion 214 of the connector 206. Deformation of the crimp ring 514 forces portions of the hose segment 516 into the space between the circumferential ridges 220 on the lower portion 214 of the connector 206, which forms a water tight seal between the connector 206 and the hose segment 516 of the PEX hose assembly 506. Deformation of the crimp ring 514 also prevents the hose segment 516 from becoming dislodged from the connector 206. Thereafter, the PEX hose assembly 506 can be removed from the connector 206 by removing the crimp ring 514 and the hose segment 516 from around the connector 206. As noted above, the PEX hose assembly 506 could also be connected to and removed from the input connector 308 or the output connector 310 of the valve assembly 300 using similar techniques. Accordingly, tools are likely needed to install and uninstall the PEX hose assemblies (e.g., the hose assemblies 506, 508, 510) with respect to the corresponding multi-attachment fittings.

In view of the above, the connector 206 on the spout shank assembly 200 is a multi-attachment fitting operable to interface with hosing, piping or other conduit using one of at least two distinct connection methods. The input connector 308 on each valve assembly 300 is a multi-attachment fitting operable to interface with hosing, piping or other conduit using one of at least two distinct connection methods. The output connector 310 on each valve assembly 300 is a multi-attachment fitting operable to interface with hosing, piping or other conduit using one of at least two distinct connection methods.

The above description of specific embodiments has been given by way of example. From the disclosure given, those skilled in the art will not only understand the general inventive concept and its attendant advantages, but will also find apparent various changes and modifications to the structures and methods disclosed. For example, although the above exemplary embodiments were described in relation to mounting a spout on a mounting surface, the general inventive concept is applicable to mounting other plumbing fixtures, such as a shower head post or tube. As another example, one of ordinary skill in the art will appreciate that the quick-connect and PEX connection techniques disclosed herein are merely exemplary and that the general inventive concept encompasses variations to these connection methods, as well as other connection methods known in the art. It is sought, therefore, to cover all such changes and modifications as fall within the spirit and scope of the general inventive concept, as defined by the appended claims, and equivalents thereof.

1. A water delivery apparatus comprising a fitting operable to connect the water delivery apparatus to a water supply source,
wherein the fitting includes a first portion operable to connect to a first fluid conduit using a first connection method, and
wherein the fitting includes a second portion operable to connect to a second fluid conduit using a second connection method.

2. The water delivery apparatus of claim 1, wherein the first fluid conduit is a quick-connect hose.

3. The water delivery apparatus of claim 1, wherein the second fluid conduit is a PEX hose.

4. The water delivery apparatus of claim 1, wherein a maximum circumference of the first portion is greater than a maximum circumference of the second portion.

5. The water delivery apparatus of claim 1, wherein the first portion includes a groove for receiving an O-ring.

6. The water delivery apparatus of claim 1, wherein the second portion includes texture for interfacing with a crimp ring.

7. The water delivery apparatus of claim 6, wherein the texture is a ridge.

8. The water delivery apparatus of claim 1, wherein the water delivery apparatus includes a spout shank assembly.

9. The water delivery apparatus of claim 1, wherein a water control apparatus is disposed between the water delivery apparatus and the water supply source.

10. The water delivery apparatus of claim 9, wherein the water control apparatus is a valve assembly.

11. A water delivery system, the system comprising:
a water delivery fixture including a first fitting, and
a valve assembly including a second fitting and a third fitting,
wherein the first fitting includes a first portion operable to connect to a first fluid conduit using a first connection method,
wherein the first fitting includes a second portion operable to connect to a second fluid conduit using a second connection method,
wherein the second fitting includes a first portion operable to connect to the first fluid conduit using the first connection method,
wherein the second fitting includes a second portion operable to connect to the second fluid conduit using the second connection method,
wherein the third fitting includes a first portion operable to connect to a third fluid conduit using the first connection method, and
wherein the third fitting includes a second portion operable to connect to a fourth fluid conduit using the second connection method.

12. The water delivery system of claim 11, wherein the first fluid conduit is a quick-connect hose, and
wherein the third fluid conduit is a quick-connect hose.

13. The water delivery system of claim 11, wherein the second fluid conduit is a PEX hose, and
wherein the fourth fluid conduit is a PEX hose.

14. The water delivery system of claim 11, wherein a maximum circumference of the first portion of the first fitting is greater than a maximum circumference of the second portion of the first fitting,
wherein a maximum circumference of the first portion of the second fitting is greater than a maximum circumference of the second portion of the second fitting, and
wherein a maximum circumference of the first portion of the third fitting is greater than a maximum circumference of the second portion of the third fitting.

15. The water delivery system of claim 11, wherein the first portion of the first fitting includes a groove for receiving an O-ring,
wherein the first portion of the second fitting includes a groove for receiving an O-ring, and
wherein the first portion of the third fitting includes a groove for receiving an O-ring.

16. The water delivery system of claim 11, wherein the second portion of the first fitting includes texture for interfacing with a crimp ring,
wherein the second portion of the second fitting includes texture for interfacing with a crimp ring, and
wherein the second portion of the third fitting includes texture for interfacing with a crimp ring.

17. The water delivery system of claim 16, wherein the texture on the first fitting is a ridge,
wherein the texture on the second fitting is a ridge, and
wherein the texture on the third fitting is a ridge.

18. The water delivery system of claim 11, wherein the water delivery fixture includes a spout shank assembly.

19. The water delivery system of claim 11, wherein the valve assembly is operable to control at least one of a flow rate and a temperature of water flowing from a water supply source to the water delivery fixture.

20. A system for delivering water, the system comprising:
a water delivery fixture including a first fitting,
a first valve assembly including a second fitting and a third fitting, and
a second valve assembly including a fourth fitting and a fifth fitting,
wherein the first fitting includes a first portion operable to connect to a first fluid conduit using a first connection method,
wherein the first fitting includes a second portion operable to connect to a second fluid conduit using a second connection method,
wherein the second fitting includes a first portion operable to connect to the first fluid conduit using the first connection method,
wherein the second fitting includes a second portion operable to connect to the second fluid conduit using the second connection method,
wherein the third fitting includes a first portion operable to connect to a third fluid conduit using the first connection method,
wherein the third fitting includes a second portion operable to connect to a fourth fluid conduit using the second connection method,
wherein the fourth fitting includes a first portion operable to connect to the first fluid conduit using the first connection method,
wherein the fourth fitting includes a second portion operable to connect to the second fluid conduit using the second connection method,
wherein the fifth fitting includes a first portion operable to connect to a fifth fluid conduit using the first connection method, and
wherein the fifth fitting includes a second portion operable to connect to a sixth fluid conduit using the second connection method.
